(19) United States
(12) Patent Application Publication
(10) Pub. No.: US 2002/0083038 A1
(43) Pub. Date: Jun. 27, 2002

(54) Unit for managing data stored in a data processing device

(76) Inventor: Stefan Berndt, Unna-Hemmere (DE)

Correspondence Address: BELL, BOYD & LLOYD, LLC, P. O. BOX 1135, CHICAGO, IL, 60690-1135, US

(21) Appl. No.: 09/997,591

(22) Filed: Nov. 28, 2001

(30) Foreign Application Priority Data
Nov. 28, 2000 (DE) 100 59 103.5

(51) Int. Cl. G06F 7/00

(52) U.S. Cl. 707/1

(57) ABSTRACT

A unit for managing data stored in a data processing device which includes a first interface to applications which initialize access to the data and a second interface to an access unit which provides access mechanisms for different memory structures, the unit providing the applications with the appropriate data by accessing the access unit. The applications are preferably produced on an object-oriented basis, the application being provided with the data by the unit already in the form of required objects.

### BACKGROUND OF THE INVENTION

Software modules or applications, running on a data processing device to work properly, require module-specific or application-specific data; e.g., “configuration data and metadata”. These configuration data and metadata are generally stored in different storage media, e.g. in a relational database or in a directory, and are therefore stored in various memory structures.

Modem software modules or applications are frequently object-oriented implementations (for example, programmed in the known programming language C++) whose data need to be serialized in the different storage media; i.e., objects and attributes of the object-oriented data need to be appropriately converted for storage in a storage medium. For this, the individual software modules or applications respectively require information about the storage medium in which the relevant data are to be stored, information about the memory structure of the respective storage medium (frequently referred to in literature as metadata), and the necessary mechanisms for appropriate memory access.

Producing the individual software modules or applications with the appropriate information and mechanisms is associated with a high level of complexity, however, which makes it difficult to change these software modules or applications.

The present invention is, therefore, directed toward specifying measures which make it possible to simplify memory access to data stored in a storage medium from an application.

### SUMMARY OF THE INVENTION

A fundamental advantage of the inventive unit is that setting up an intermediate layer between application and memory unit allows for the application to require no further information about the storage location and the memory structure and, hence, implementation of applications can be simplified. In addition, it is a simple matter to combine various storage media with one another and to present them to an application as one large cohesive storage medium.

An advantage of one embodiment of the present invention is, among other things, that providing a consistency module allows for, when data are changed, data which are dependent on these changed data to be likewise changed automatically, and other applications accessing the changed data in parallel, frequently referred to in literature as multiple access, are informed about the change.

Another advantage offered by an embodiment of the present invention is that, with object-oriented implementation of applications, an application is provided with the data already in the form of required objects. Thus, it is no longer necessary to serialize or deserialize the data during memory access.

In addition, the provision of such an intermediate layer simplifies a change from a conventional memory structure to an object-oriented structure; e.g., to an object-oriented database.

Additional features and advantages of the present invention are described in, and will be apparent from, the following Detailed Description of the Invention and the Figures.

### BRIEF DESCRIPTION OF THE FIGURES

FIG. 1 shows a structogram for schematically illustrating the fundamental functional units involved in the present invention.

FIG. 2 shows a flowchart to illustrate the fundamental method steps taking place when data are changed in a database.

### DETAILED DESCRIPTION OF THE INVENTION

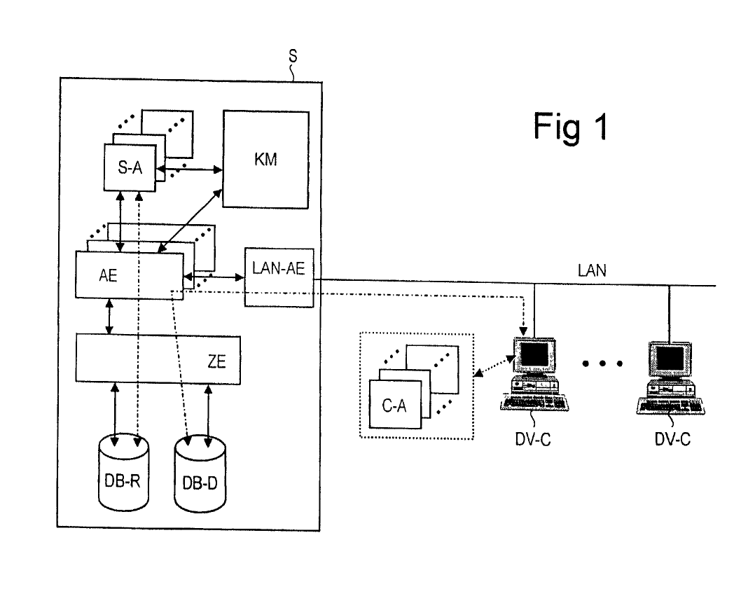

FIG. 1 shows a “client-server architecture” having a central data processing device S, referred to in literature as the server, and a number of local data processing devices DV-C, referred to in literature as clients. The central data processing device S and the local data processing devices DV-C are connected to one another via a local area network LAN.

The local data processing devices DV-C run local applications C-A; illustrated schematically by the dashed box for one of the local data processing devices DV-C. In addition, the central data processing device S runs central applications S-A. In the present exemplary embodiment, the applications C-A, S-A are applications produced on an object-oriented basis; i.e., they are applications created using an object-oriented programming language (e.g., using the known programming language C++).

For the applications C-A, S-A to run properly, the applications C-A, S-A need to access data stored in databases in the central data processing device S; indicated schematically by the dash-dot lines. By way of example, a first database DB-R, for example a relational database, and a second database DB-D, for example a directory, are shown. The databases DB-R, DB-D have different memory structures, wherein different access mechanisms are required in order to access the databases DB-R, DB-D.

Access to the databases DB-R, DB-D by the applications C-A, S-A is controlled by an inventive abstraction unit AE which has three interfaces for connection to the units required for this purpose in the central and local data processing devices S, DV-C. In this context, any central application S-A running on the central data processing device S and any local applications C-A running on the local data processing devices DV-C have a respectively associated application-specific abstraction unit AE.

In this case, a first interface is used to connect the abstraction unit AE to the applications C-A, S-A performing memory access. In this context, the applications C-A, S-A can be connected to the abstraction unit AE directly in the case of central applications S-A running on the central data processing device S, or via a network interface unit LAN-AE, arranged in the central data processing device S, and the local area network LAN in the case of local applications C-A running on the local data processing devices DV-C. A second interface is used to connect the abstraction unit AE to an access unit ZE providing access mechanisms for the different databases DB-R, DB-D. A third interface is used to set up a connection to a “consistency module” KM, the consistency module KM providing automatic notification of and updating for the changed data for other applications S-A, C-A accessing the changed data in parallel.

The abstraction units AE appropriately convert data which are to be written to one of the databases DB-R, DB-D and are transferred in the form of objects from an application S-A, C-A to the abstraction unit AE; i.e., serialize them and write them to the appropriate database DB-R, DB-D. Similarly, the abstraction unit AE appropriately deserializes data which are to be read from the databases DB-R, DB-D; i.e., converts them into required objects and transfers them to the appropriate application S-A, C-A requesting the data.

Particularly in distributed system, or network-wide systems, it is appropriate to implement such an abstraction unit AE for software implementations on the basis of the “3-tier architecture”. On the basis of the “3-tier architecture”, there is a division between a “presentation tier”, in this case an application S-A, C-A, a “business tier”, in this case comparable with the abstraction unit AE, and a “data tier”, in this case a database DB-R, DB-D. With the “3-tier architecture”, it is normal to implement information about the type of associated database DB-R, DB-D and the structure of the stored data in the “presentation tier”, wherein changes to the “presentation tier” are associated with a high level of complexity. This drawback can be eliminated by the inventive abstraction unit AE. By way of example, such a “3-tier architecture” is produced using component techniques; e.g., COM/DCOM from the company Microsoft or CORBA. Particularly in the case of local implementations, an abstraction unit AE also may be implemented for solutions based on a library approach; e.g., DLL.

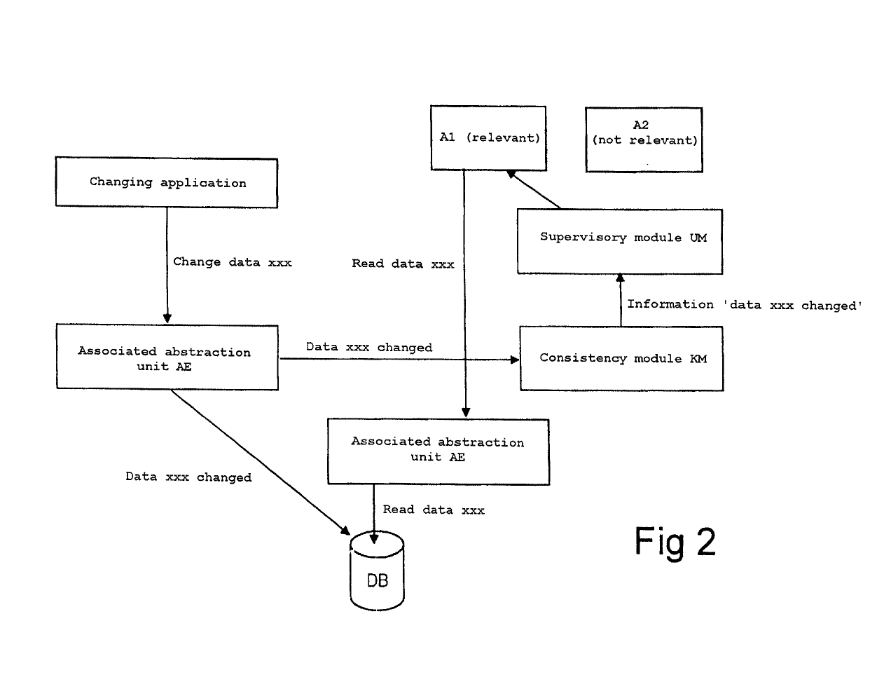

FIG. 2 shows a flowchart to illustrate the fundamental method steps taking place when data are changed in a database DB. If a changing application transmits a message “change data xxx” to an abstraction unit AE associated with the changing application, this abstraction unit AE uses the second interface and accesses the access unit ZE in order to change the data xxx in the appropriate database DB. At the same time or after the data xxx have been changed, this abstraction unit AE uses the third interface to transmit a message “data xxx changed” to the consistency module KM.

The consistency module KM, in turn, transmits information stating that the data xxx have been changed to an associated supervisory module UM. The supervisory module UM stores information about which applications A1, A2 are affected by a change in the data; i.e., which of the applications A1, A2 access the changed data xxx in parallel. In the present exemplary embodiment, two applications A1, A2 are shown, the change in the data xxx being relevant to a first application A1 and not being relevant to a second application A2.

In a subsequent step, the supervisory module UM transmits a message about the data xxx having been changed to the first application A1, which then transmits a message “read data xxx” to an abstraction unit AE associated with the first application A1. Upon receiving this message, the abstraction unit AE uses the second interface and accesses the access unit ZE in order to prompt read access to the data xxx in the appropriate database DB, and transmits the new data xxx to the first application A1 via the first interface. The method described is a simple way of providing notification of and updating for the changed data xxx for a multiplicity of applications, despite there being different storage media.

Although the present invention has been described with reference to specific embodiments, those of skill in the art will recognize that changes may be made thereto with departing from the spirit and scope of the invention as set forth in the hereafter appended claims.

1. A unit for managing data stored in a first data processing device, comprising:
a first interface to an application which initializes access to the data; and
a second interface to an access unit which provides access mechanisms for different memory structures, wherein the unit provides the application with appropriate data by accessing the access unit.

2. A unit for managing data stored in a first data processing device as claimed in claim 1, wherein the application is produced on an object-oriented basis, and the data are provided in the form of required objects.

3. A unit for managing data stored in a first data processing device as claimed in claim 1, farther comprising:
a third interface to a consistency module for automatically updating changed data in further applications accessing the same data.

4. A unit for managing data stored in a first data processing device as claimed in claim 1, wherein the application runs on the fist data processing device in which the data are stored.

5. A unit for managing data stored in a first data processing device as claimed in claim 1, further comprising:
a second data processing device, wherein the application runs on the second data processing device and the data are stored in the first data processing device, the first and second data processing devices being connected to one another via a network.

6. A unit for managing data stored in a first data processing device as claimed in claim 5, wherein the unit is arranged in the first data processing device.

7. A unit for managing data stored in a first data processing device as claimed in claim 5, wherein the first interface is used for connection to a network interface unit.

8. A unit for managing data stored in a first data processing device as claimed in claim 1, wherein for a plurality of applications, each application has a respectively associated application-specific unit.
